(19) United States
(12) Patent Application Publication
(10) Pub. No.: US 2005/0288985 A1
(43) Pub. Date: Dec. 29, 2005

(54) SYSTEM AND METHOD FOR FACILITATING A SALES TRANSACTION OF AN EMPLOYMENT POSITION BETWEEN AN INDIVIDUAL POSSESSING THE POSITION AND AN INDIVIDUAL SEEKING EMPLOYMENT IN THE POSITION

(76) Inventor: Ben Kane, Chicago, IL (US)

Correspondence Address: FACTOR & LAKE, LTD, 1327 W. WASHINGTON BLVD., SUITE 5G/H, CHICAGO, IL, 60607, US

(21) Appl. No.: 11/160,541

(22) Filed: Jun. 28, 2005

Related U.S. Application Data
(60) Provisional application No. 60/521,733, filed on Jun. 28, 2004.

(51) Int. Cl. G06Q 10/00

(52) U.S. Cl. 705/8

(57) ABSTRACT

A system and method is provided for facilitating a sale of an employment position with an employer (“firm”) from an employee (“seller”) possessing the employment position (“job”) to an individual seeking employment and desiring the position (“buyer”). The method is most preferably implemented via an Internet web-based system providing one or more user interface modules accessible via a web portal. According to a particular embodiment, a method comprises the steps of accepting information from the employee relating to the position, wherein the information includes a price associated with the position; verifying the information; publishing the information such that it is accessible to a plurality of individuals seeking employment; accepting an application for the position from at least one of the plurality of individuals; and effectuating payment of the price associated with the position from the at least one of the plurality of individuals to the employee after approval by the employer of the at least one of the plurality of individuals. Other methods and systems relating to these methods are also disclosed.

### CROSS REFERENCE TO RELATED APPLICATION

This application claims priority to U.S. Provisional Patent Application Ser. No. 60/521,733, filed Jun. 28, 2004, which is incorporated herein by reference.

### BACKGROUND OF INVENTION

The present invention generally relates to business methods and business models in the employment market, and more particularly to a system and method for facilitating the sale of an employment position between the position holder and an employment seeker.

Unemployment has always been a key labor market factor that adversely affects any economic system. While there are many causes and effects of unemployment, one particular cause that is often overlooked is the underlying cause of the macro-economic problem of “frictional unemployment,” i.e., unemployment caused by a mismatch between a company and an employee. The “friction” or mismatch may exist for any number of reasons, such as, for example, an employee lacking the necessary skill sets for a particular position, a personality or philosophical conflict between the company and the employee, a company lacking opportunities or challenges that are important to a particular employee, just to name a few. Employee productivity can be greatly adversely affected by such mismatches when an employee does not resign from his or her position. And when such an employee decides to leave, there are major costs and lost time involved for both the ex-employee, in terms of seeking a new job, and the employer, in terms of seeking a new employee and carrying out the hiring process. The relatively long time periods required for companies to employ personnel have direct adverse economic effects on the company.

Based on these observations, any positive redistribution of the labor market and a resulting reduction in “frictional unemployment” would be greatly beneficial to the economy, the employee, and ultimately the employer.

### SUMMARY OF INVENTION

A system and method is provided for facilitating a sales transaction of an employment position between the position holder and an individual seeking employment and desiring the position, thereby adding value to the position. An employer of the position must approve of and ultimately hire the individual desiring the position before the sales transaction is completed.

Adding value to labor in such a way provides improvements to the frictional unemployment problem. By adding value to a particular position, an employee in that position would be given incentive to remain in his current position until he found a suitable replacement willing to purchase the position from him for that value. By remaining in his position until a suitable replacement is identified, the time and cost associated with the employer replacing the employee is greatly reduced. After an initial period of job volatility, more efficient matching between employers and employees will occur. More efficient matching between employers and employees will result in increased productivity. Adding value to a particular position will also encourage potential employees to work harder since the fear of losing the position is motivated by the fear of losing the initial investment. By providing incentive to the employee to individually market his position, costs to the employer associated with hiring a new employee are reduced.

According to a particular aspect of the present invention, a method for facilitating a sale of an employment position with an employer from an employee possessing the employment position is provided. The method comprises the steps of accepting information from the employee relating to the position, wherein the information includes a price associated with the position; verifying the information; publishing the information such that it is accessible to a plurality of individuals seeking employment; accepting an application for the position from at least one of the plurality of individuals; and effectuating payment of the price associated with the position from the at least one of the plurality of individuals to the employee after approval by the employer of the at least one of the plurality of individuals.

These and other aspects of the present invention will be apparent after consideration of the written description, drawings, attachments and claims herein.

### BRIEF DESCRIPTION OF DRAWINGS

FIG. 1 is a flow chart illustrating aspects of a Seller Interface in accordance with the principles of the present invention.

FIG. 2 is a flow chart illustrating aspects of a Buyer Interface in accordance with the principles of the present invention.

FIG. 3 is a flow chart illustrating aspects of a Firm Interface in accordance with the principles of the present invention.

FIG. 4A-4X is a series of sample screen shots of various user interfaces, accompanies by a brief description of the screens, in accordance wih the principles of the present invention.

FIG. 5A-5J is a series of pages describing various features and options of the interfaces and other aspects of an embodiment of the present invention.

FIG. 6A-6C is a series of pages describing a preferred embodiment implementing one or more principles of the present invention.

FIG. 7 is a diagram illustrating a preferred financial transaction model in accordance with the principles of the present invention.

### DETAILED DESCRIPTION

While the present invention is capable of embodiment in many different forms, there is shown in the drawings, and will herein be described in detail, one or more specific embodiments with the understanding that the present disclosure is to be considered an exemplification of the principles of the invention and is not intended to limit the invention to these specific embodiments.

In accordance with the principles of the present invention, a method is provided for facilitating a sale of an employment position with an employer (sometimes referred to herein as “company” or “firm”) from an employee (“seller”) possessing the employment position (sometimes referred to herein as “job”) to an individual seeking employment and desiring the position (“buyer”). The method is most preferably implemented via an Internet web-based system providing one or more user interface modules accessible via a web portal. However, any type of Internet-based implementation within the knowledge of one skilled in the art could be utilized. The method can also be implemented via software in other server-based network systems, such as, for example, in a local area network (LAN) or in a wide area network (WAN). The method can also be implemented via software modules resident on one or more individual computers having communication capabilities with one or more other computers. It should be understood that the method can be carried out in any implementation suitable for conducting transactions between the seller, buyer and the firm.

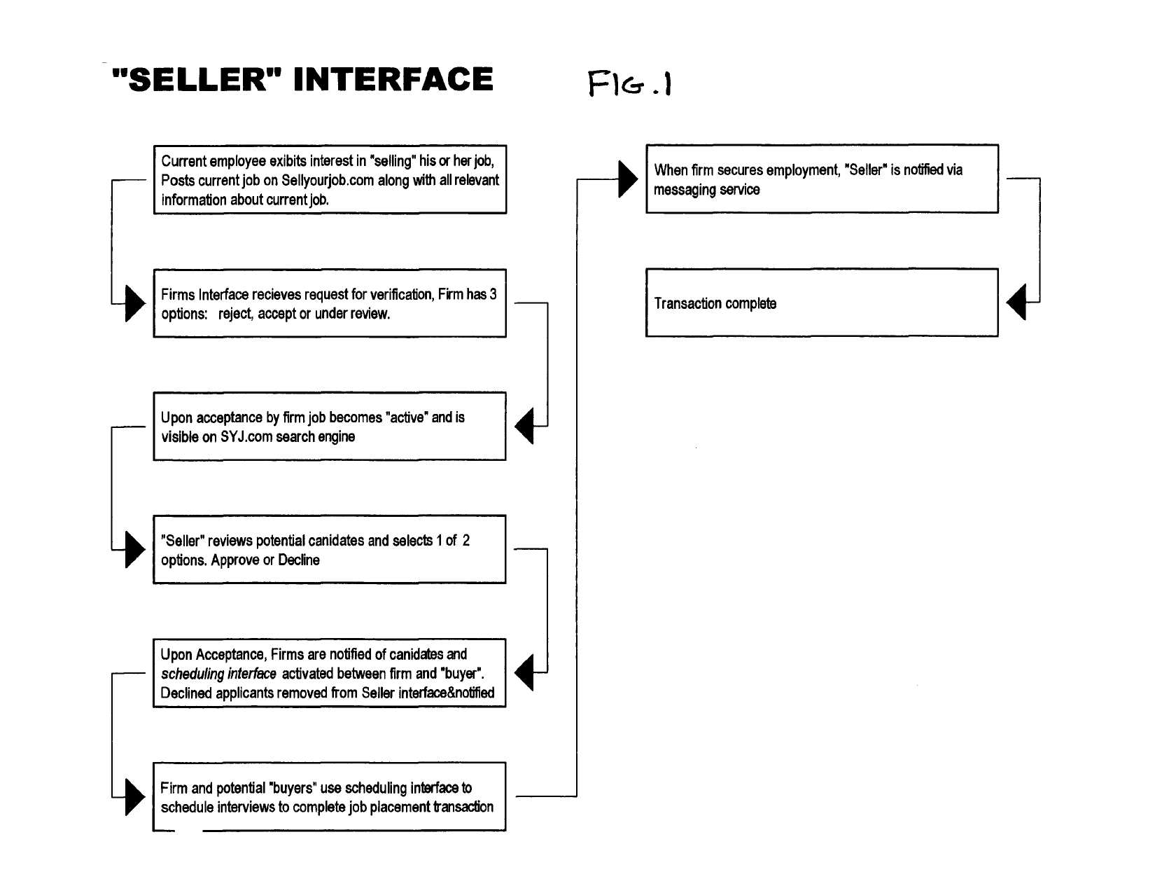

In a preferred embodiment, the system includes a Seller Interface module, a Buyer Interface module, and a Firm Interface module. Each of these interfaces may also include other sub-interfaces or sub-modules. It is contemplated that, in a preferred embodiment, an interactive website provided by a “job selling” service company can be implemented to facilitate job selling services in accordance with the principles of the methods of the invention via these modules. Each of these modules may be associated with one or more GUIs. An overview of these interfaces is shown in the flow charts illustrated in FIGS. 1-3.

System and Interface Overview

Referring to FIG. 1, the Seller Interface is initiated when a current employee of a firm decides that he wants to “sell” his job and posts his current job on the service company's website along with all relevant information regarding the job, such as job descriptions, duties, educational requirements, or the like. A price for the job is also posted, which represents the value of the job set by the seller. After the posting of a job, the Firm Interface receives a request for verification, upon which the firm has three options: reject, accept or hold pending review. Upon acceptance by the firm, the job receives active status and becomes searchable by the service's search engine on the website. At this point, job seekers (potential buyers) can review the posting and, if interested, apply for the job. The seller reviews potential candidates applications and can approve or decline them, thereby selecting one or more candidates to submit to the firm. Upon approval, the firm is notified of the candidates and a scheduling interface sub-module is activated within the Firm Interface and the Buyer Interface. Upon declining, the potential candidates are removed from the Seller Interface and notified that their application was declined. The notification is preferably implemented by use of an e-mail notification, but can also be in any form, including, for example, notification posted within the Buyer Interface, or notification by more traditional methods, such as notification by automated telephone call, notification by form letter sent via regular mail, or the like. When the firm secures employment with the buyer, the seller is then notified.

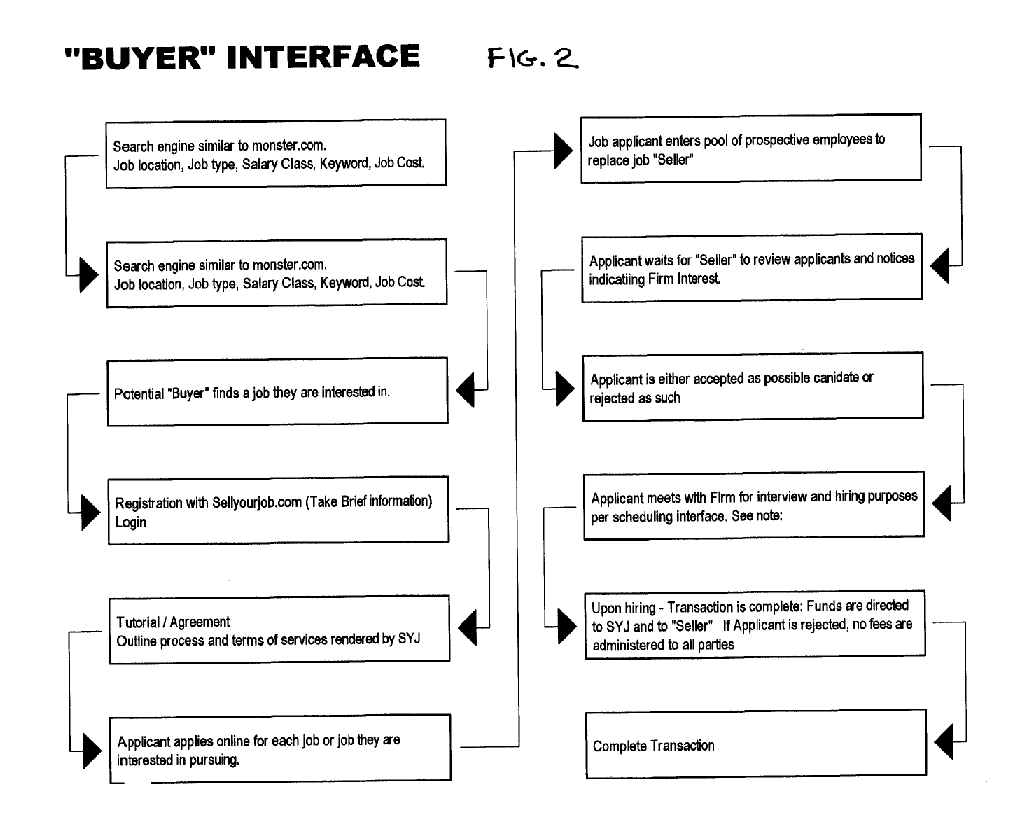

Referring to FIG. 2, the Buyer Interface includes a search engine that allows searching of job postings by any number of parameters, such as by job description, job type, salary class, job price, or key terms appearing in one or more parameter values. A potential buyer utilizes the search engine and identifies one or more jobs in which they are interested. Before being allowed to apply for any job posting, the potential buyer is then presented with a registration interface to effectuate registration with the service. The registration may include entering personal information and setting up a login name and password. The potential buyer may also be presented with a tutorial on how to use the service and the interface, and an agreement which outlines the terms of the services rendered by the service. Upon acceptance of the terms of the agreement, the potential buyer may then apply for one or more jobs in which they are interested. The potential buyer is then added to a group of prospective candidates for each of the job postings for which they applied. At this point, the potential buyer must wait for the seller to review the applications and provide notification of decline or acceptance by the seller, and ultimately wait for a notification by the firm indicating interest. If the potential buyer is notified by the firm of an interest, a scheduling interface sub-module is activated within the Buyer Interface and the Firm Interface to effectuate scheduling of an interview. If the potential buyer is hired, the transaction completes. In a preferred embodiment, funds associated with the price of the job are ultimately directed to the seller and an additional fee added to the price is directed to the service. However, other types of payments and fee arrangements are contemplated as well.

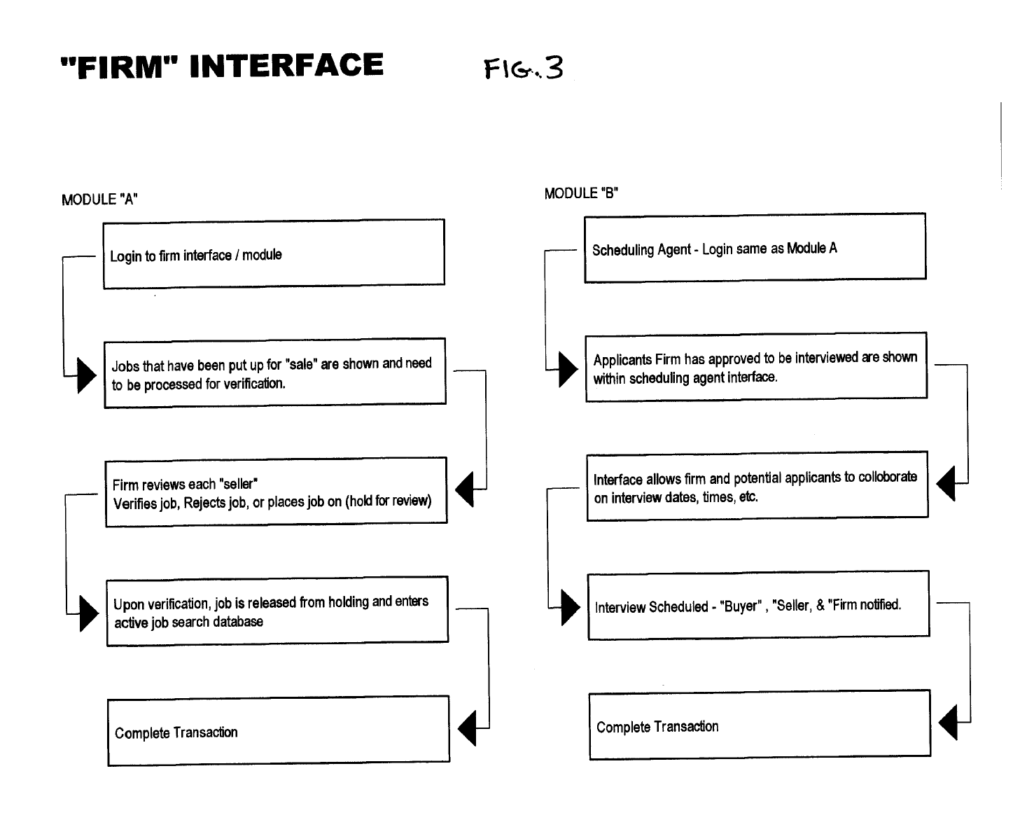

Referring to FIG. 3, the Firm Interface includes two sub-modules A and B. In sub-module A, the firm is allowed to log in and access the interface. The firm can then view job listings to identify jobs that have been “put up for sale” by sellers, which are on hold status until verified by the firm. The firm is then provided with a verification interface for each of the listings. The verification process allows the firm to verify the job, reject the job, or place it on hold for review. Upon verification, the job is released from hold status and is placed in the search database. Sub-module B provides the scheduling interface previously described, sometimes referred to as the Scheduling Agent Interface. Potential buyers that have been approved for interview by the firm are shown within the Scheduling Agent Interface, which allows the firm and potential buyers to collaborate with respect to interview scheduling, and may include facilitation of selection and confirmation of dates and times for interviews. The Scheduling Agent may optionally facilitate various arrangements for travel and accommodations if necessary. When an interview is successfully scheduled, the buyer, seller and firm are preferably notified.

The system may also include an Administration Interface which allows administration by the service of various statistical information, such as, for example, information relating to the jobs for sale; jobs sold per day, week and/or year; total applicants; total applications; total firms; active firms; jobs posted and approved by firm; and jobs posted and declined by firm. This information can be collected and help in the administration and tracking of progress of the job selling services.

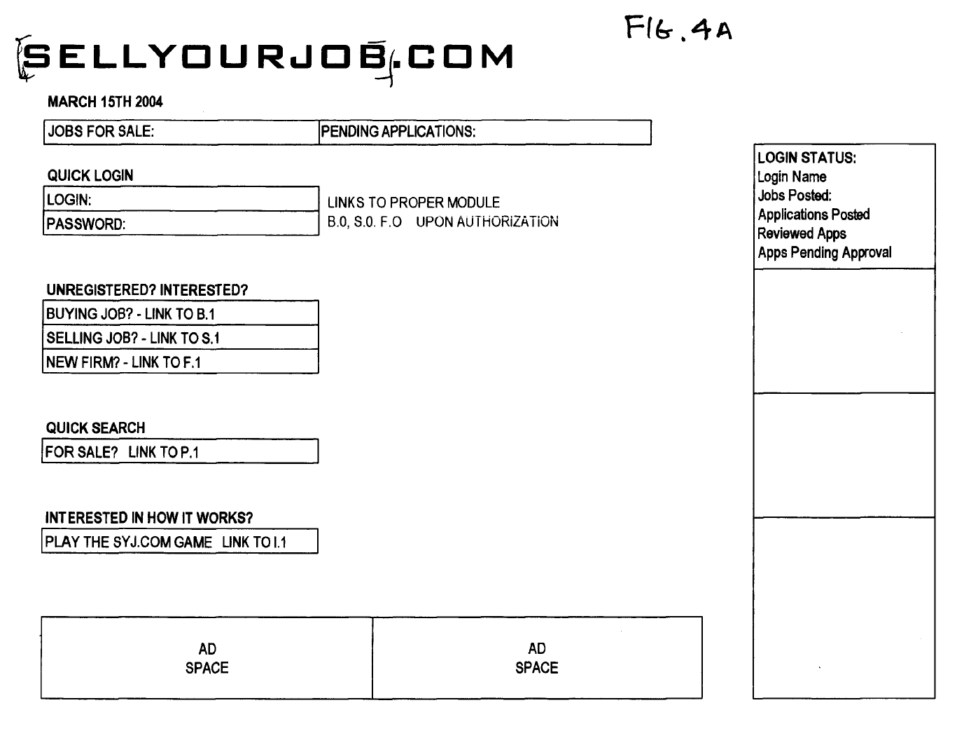

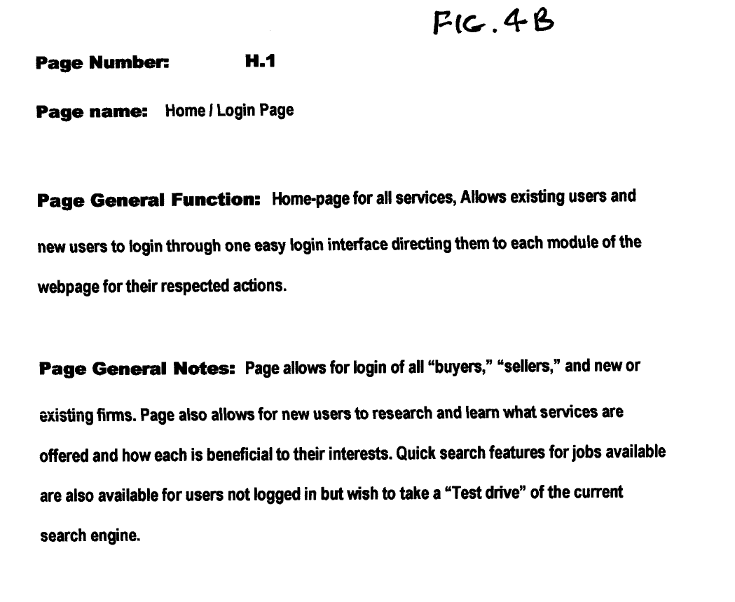

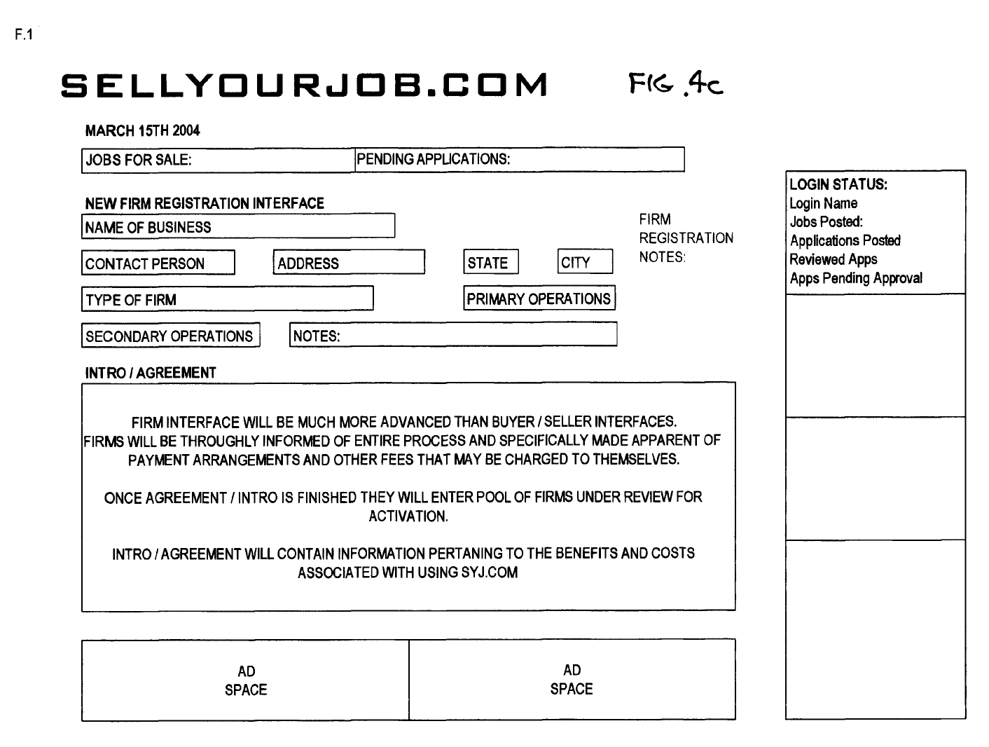

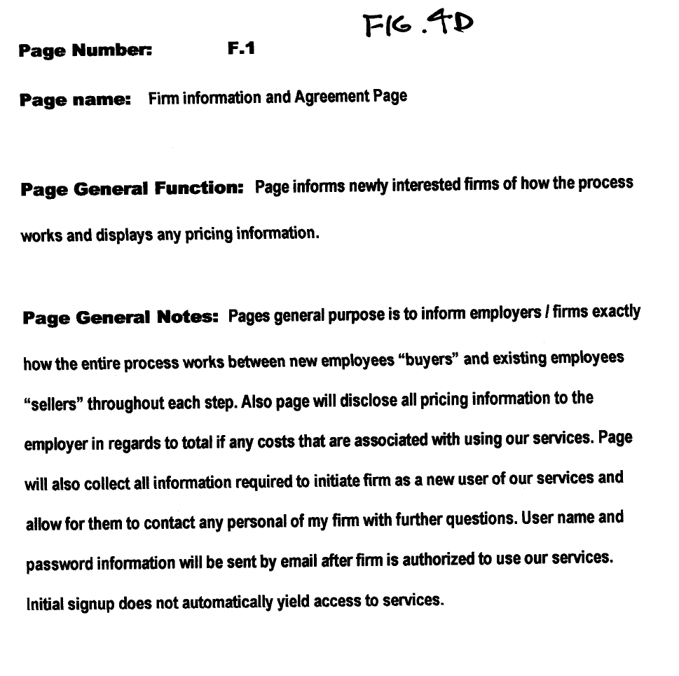

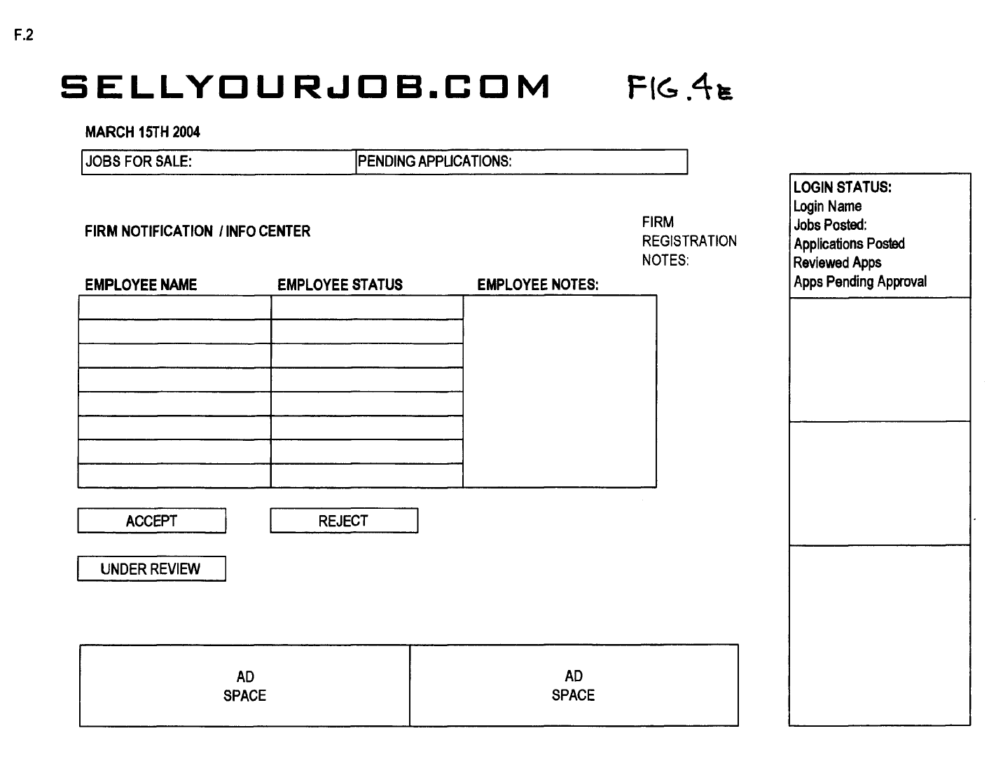

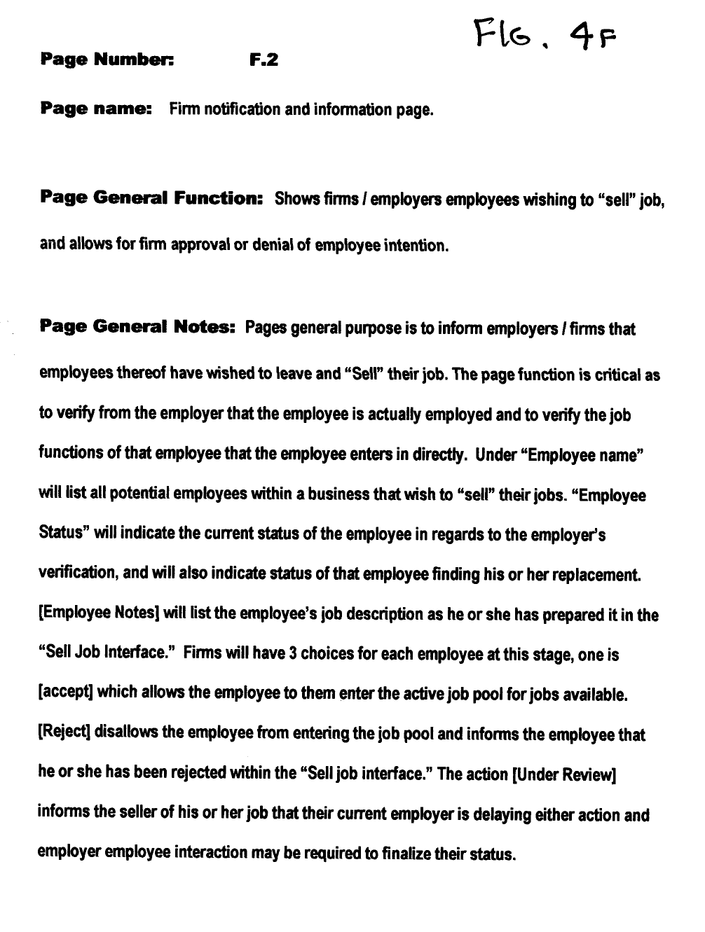

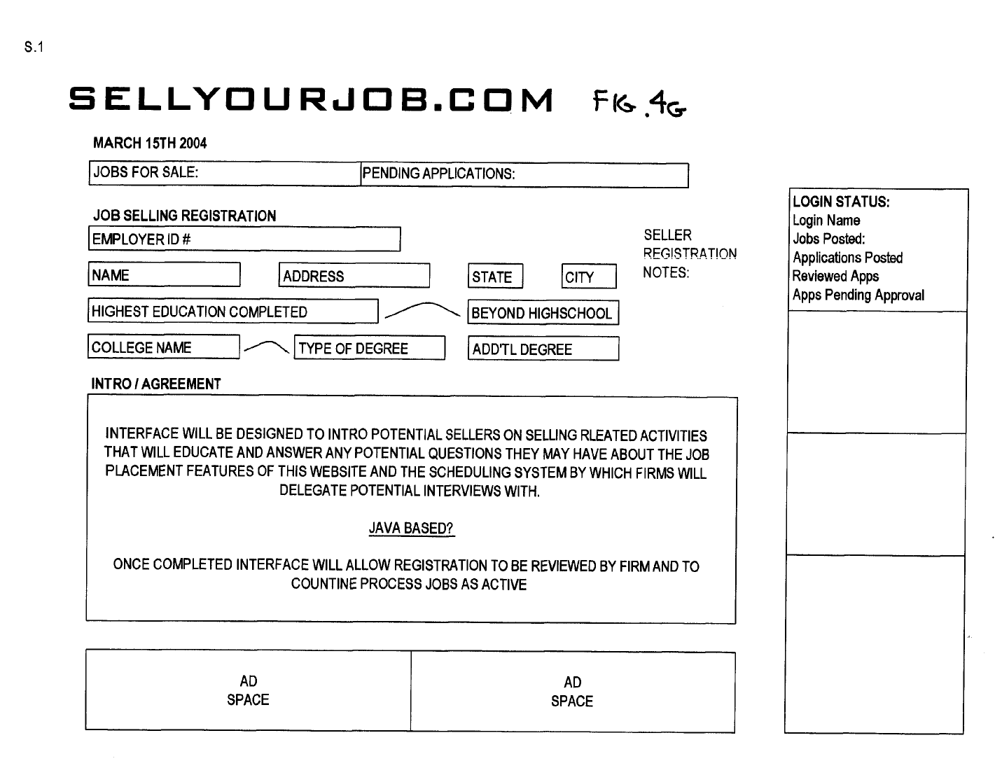

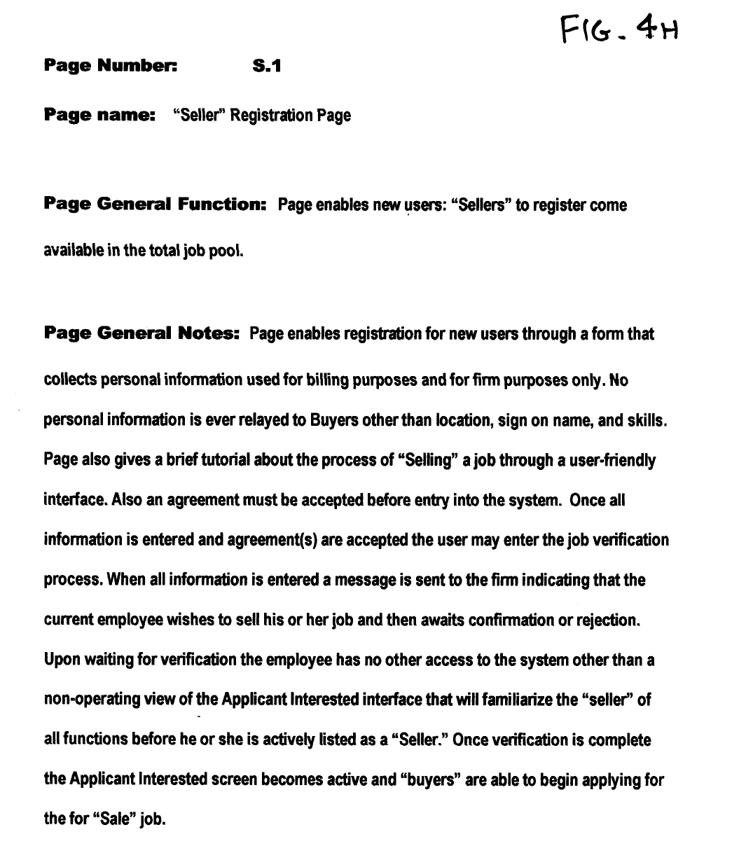

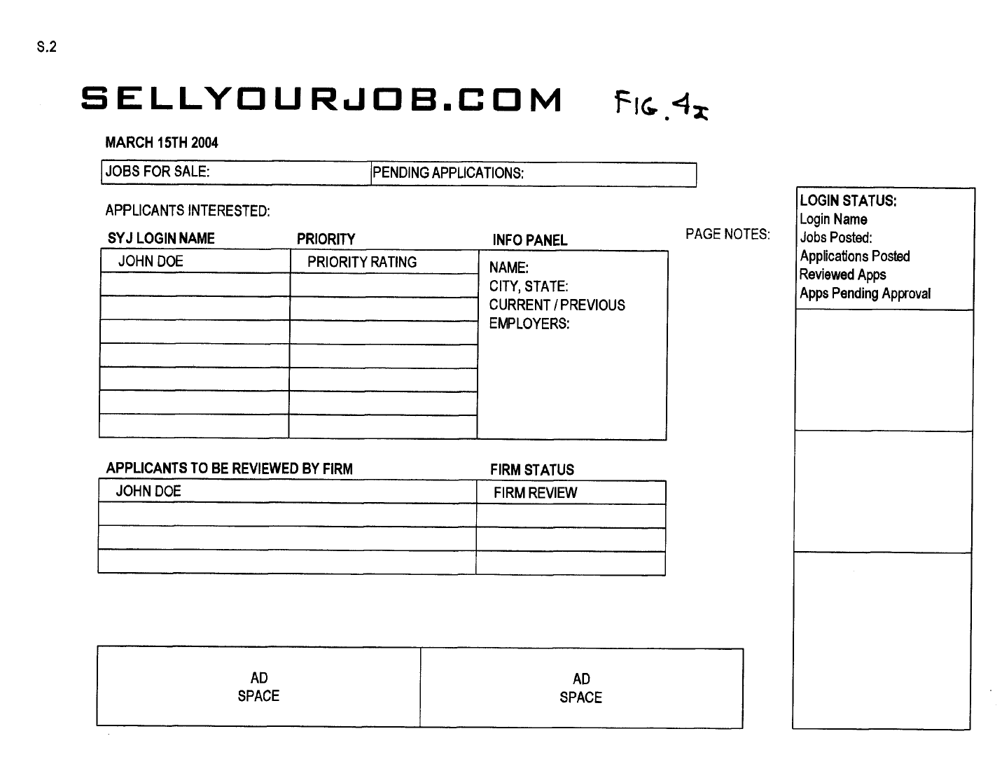

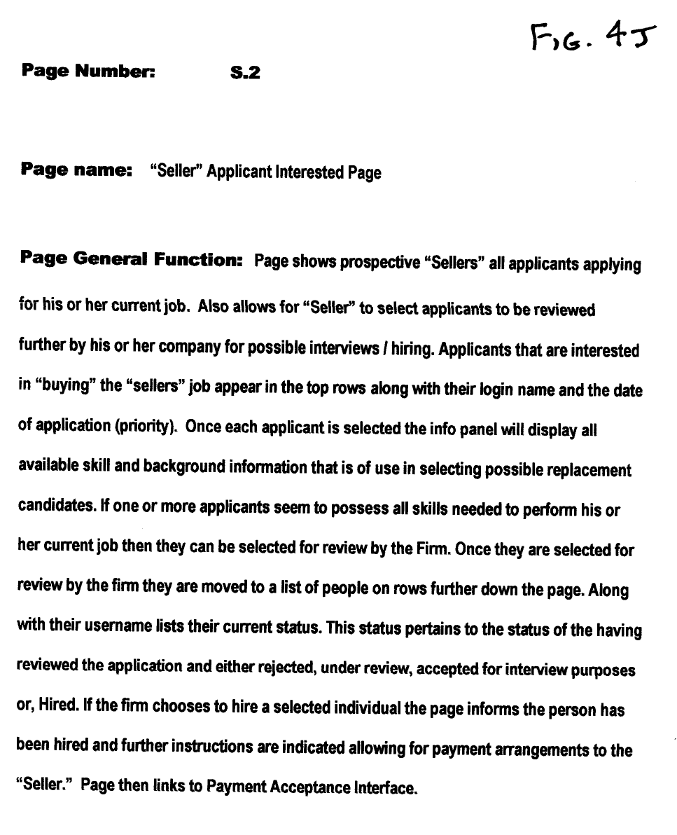

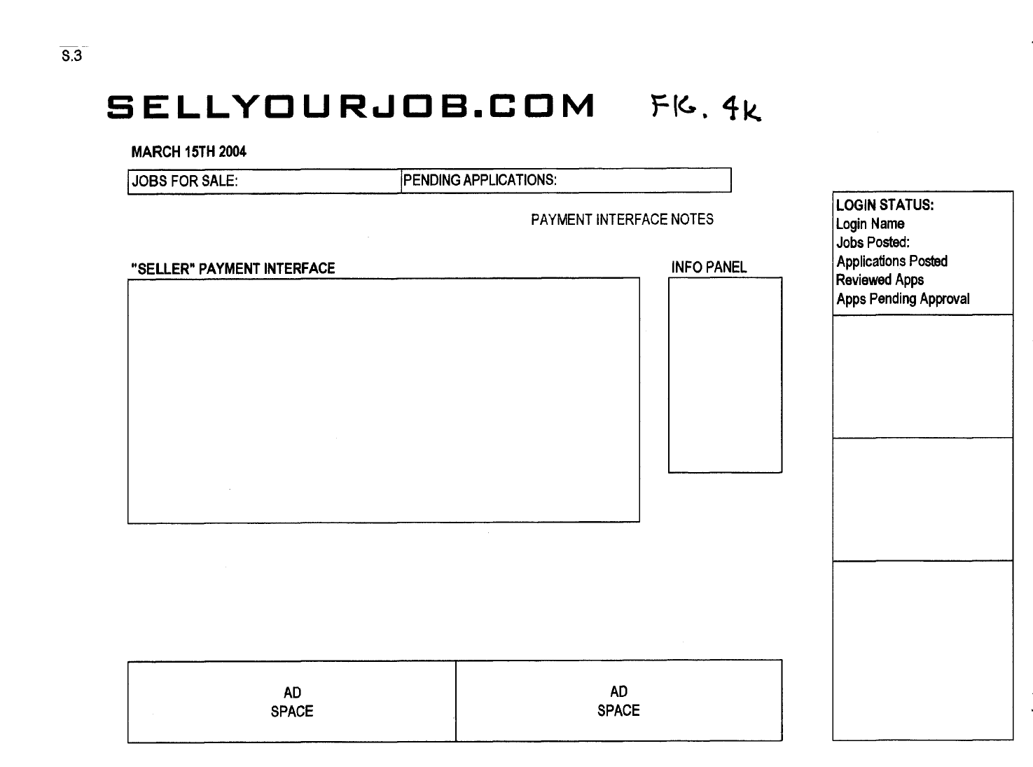

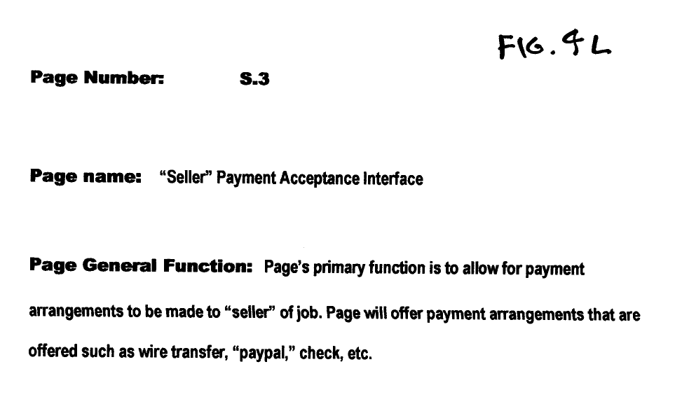

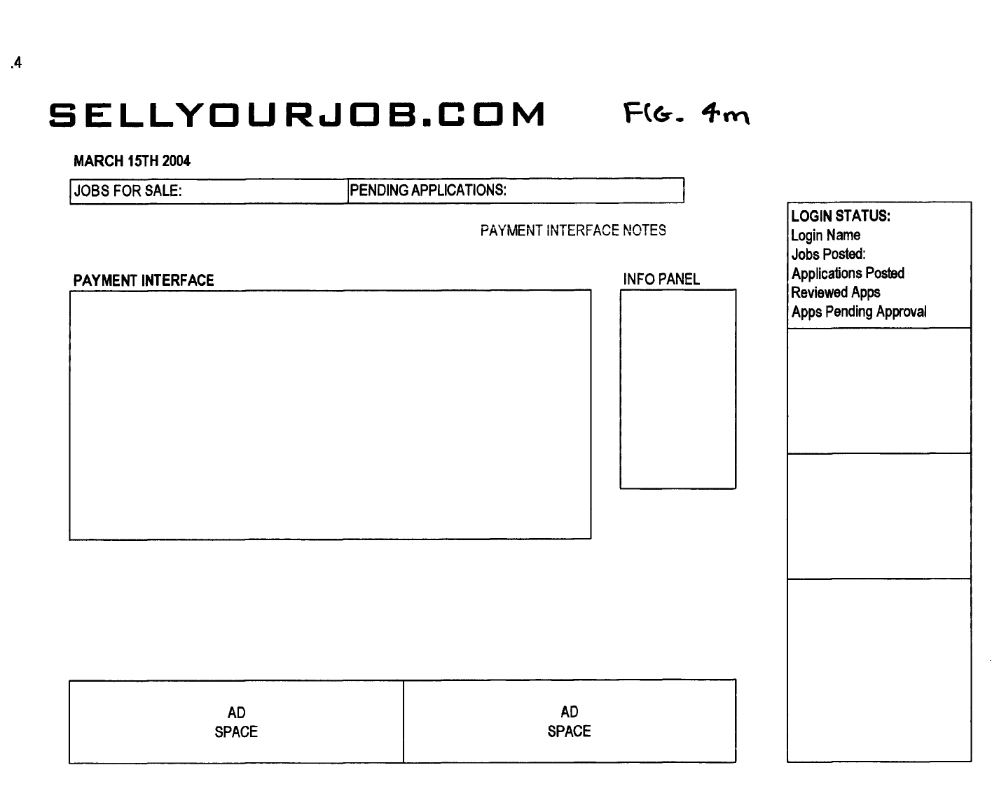

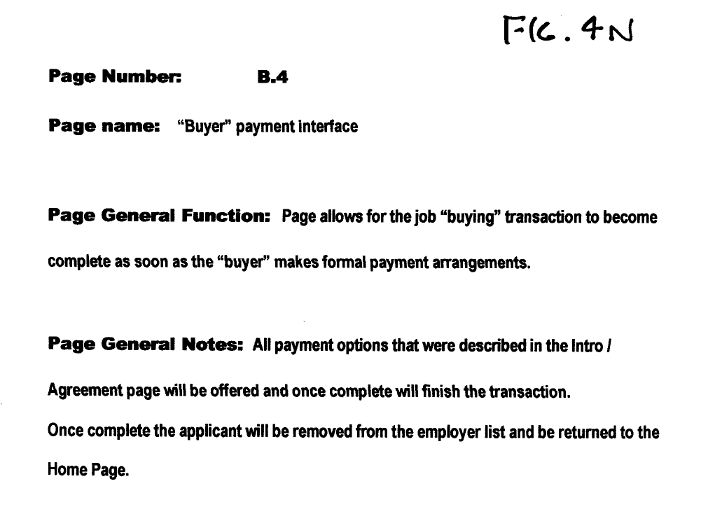

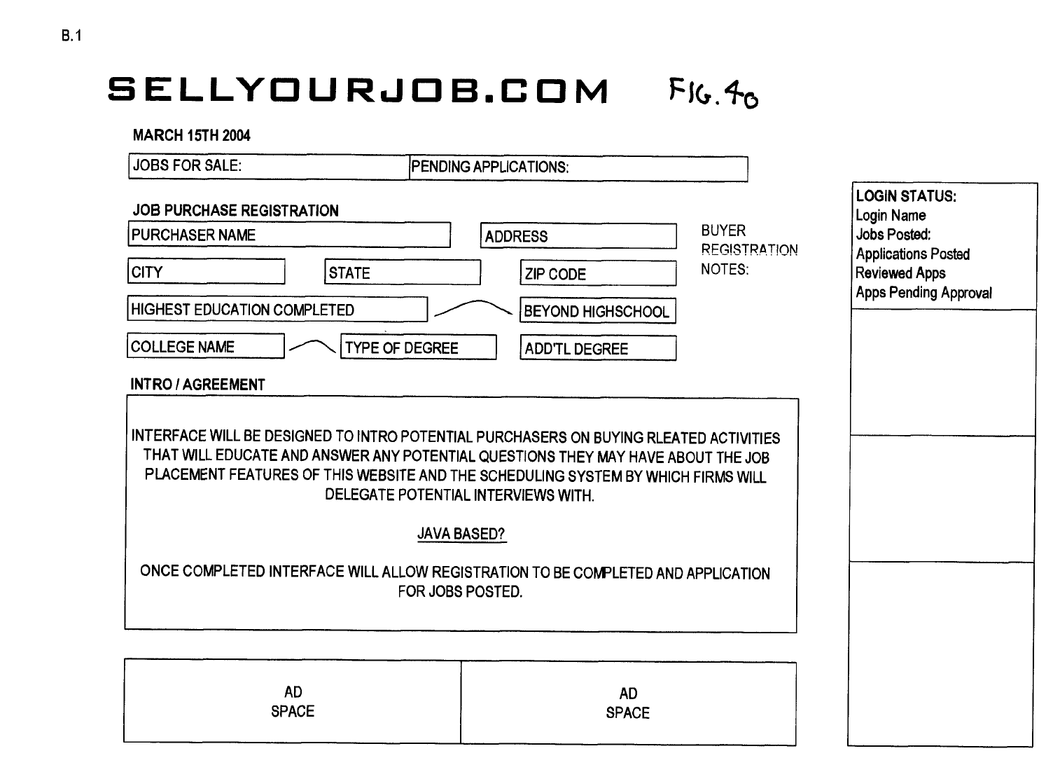

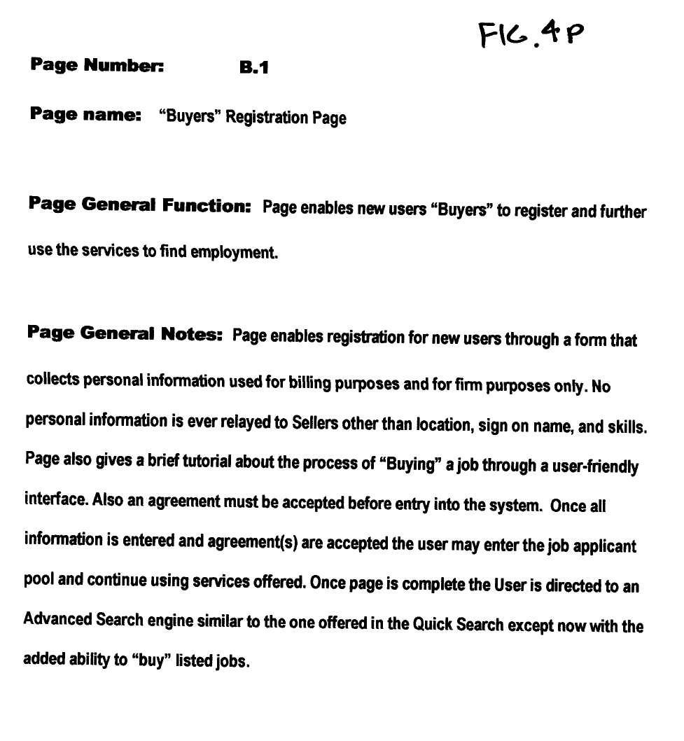

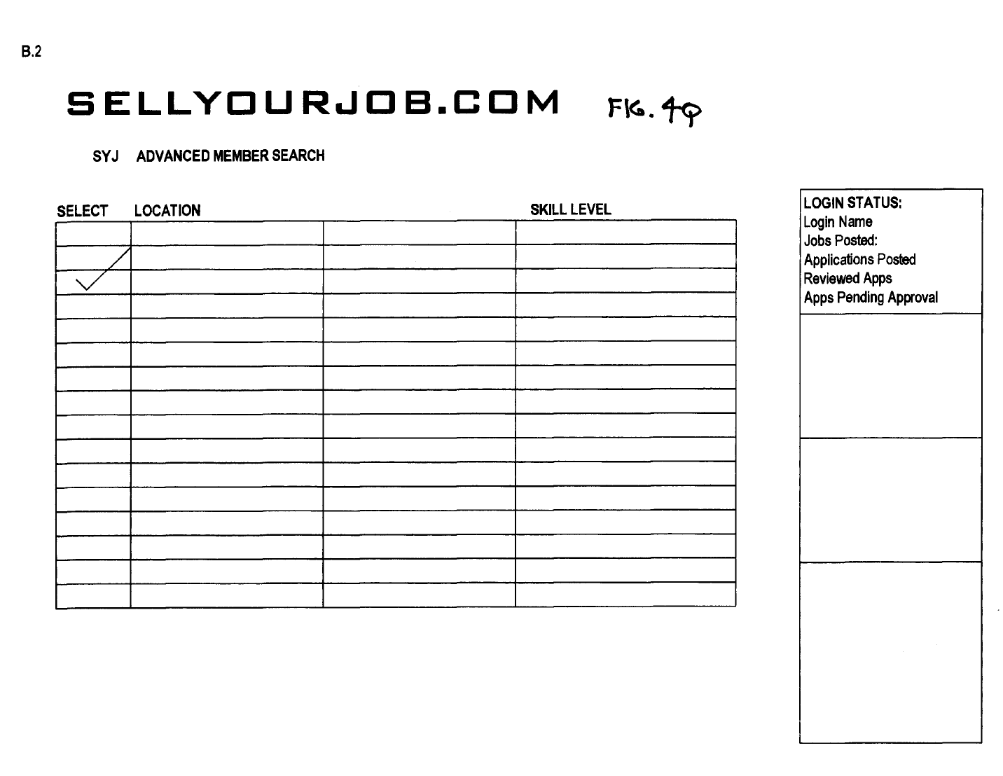

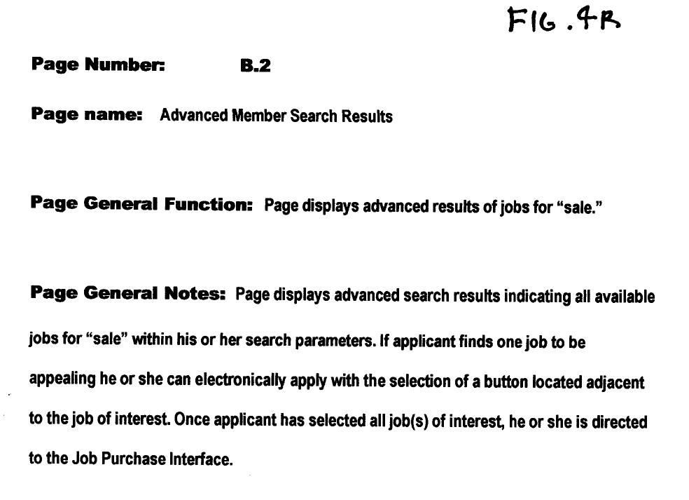

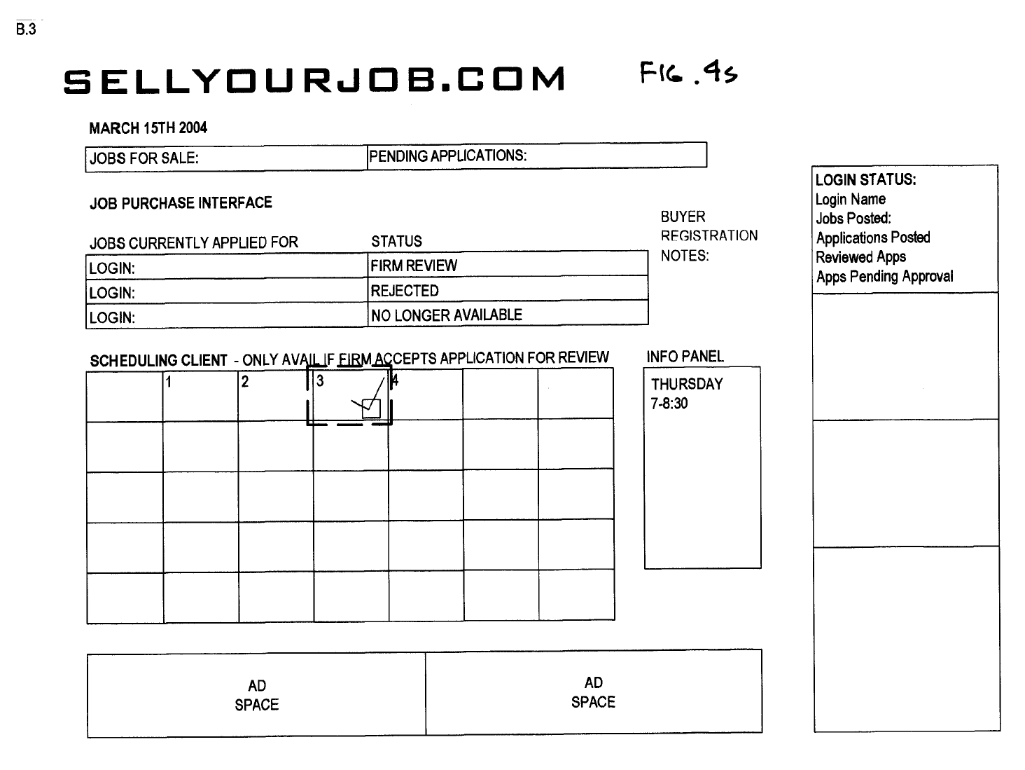

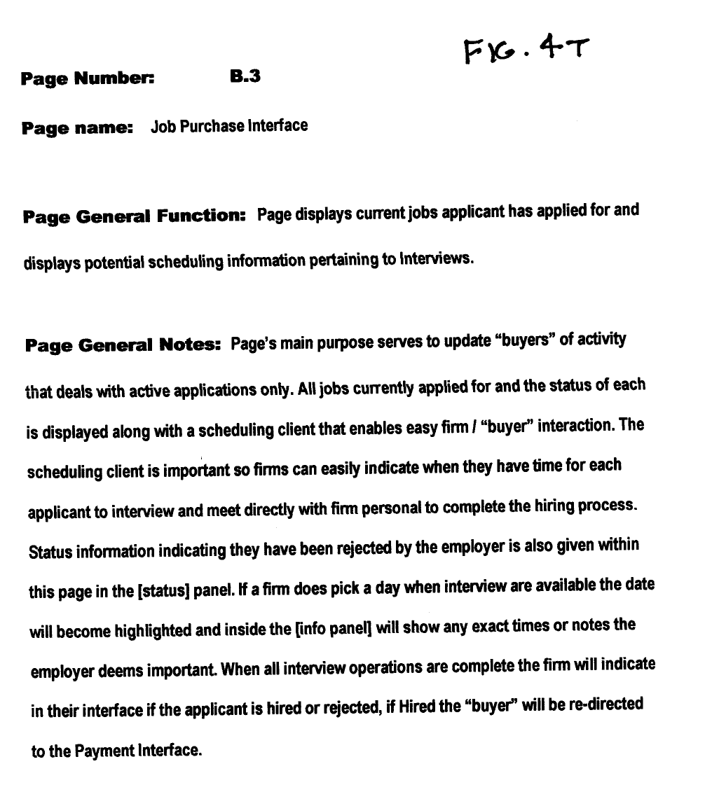

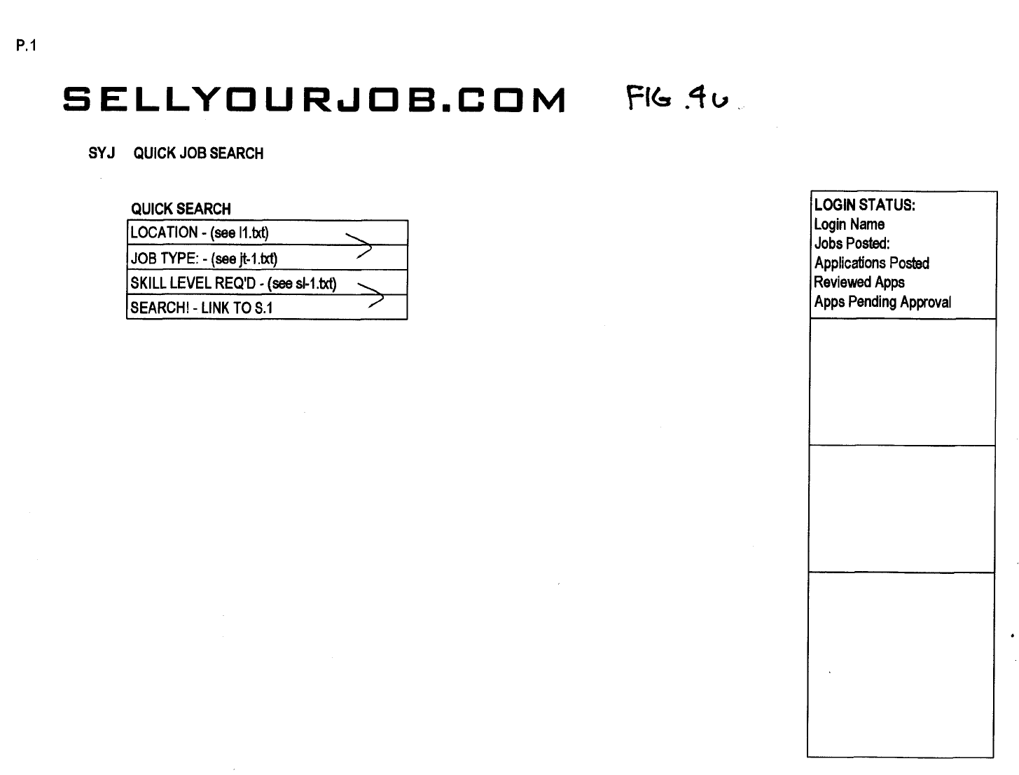

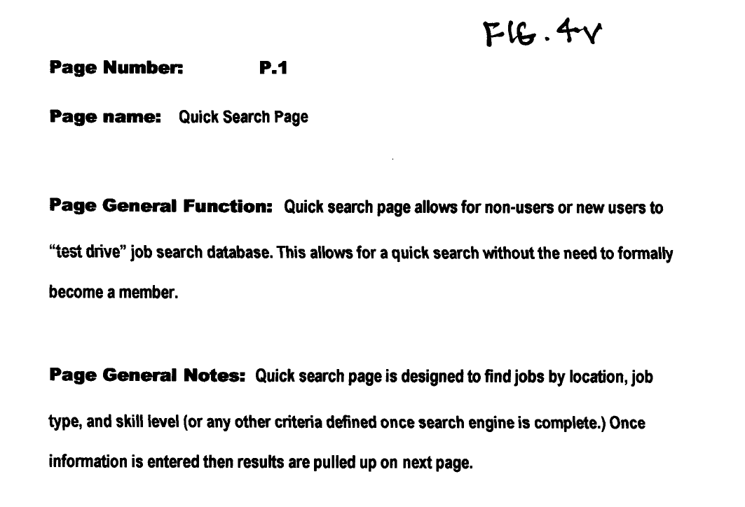

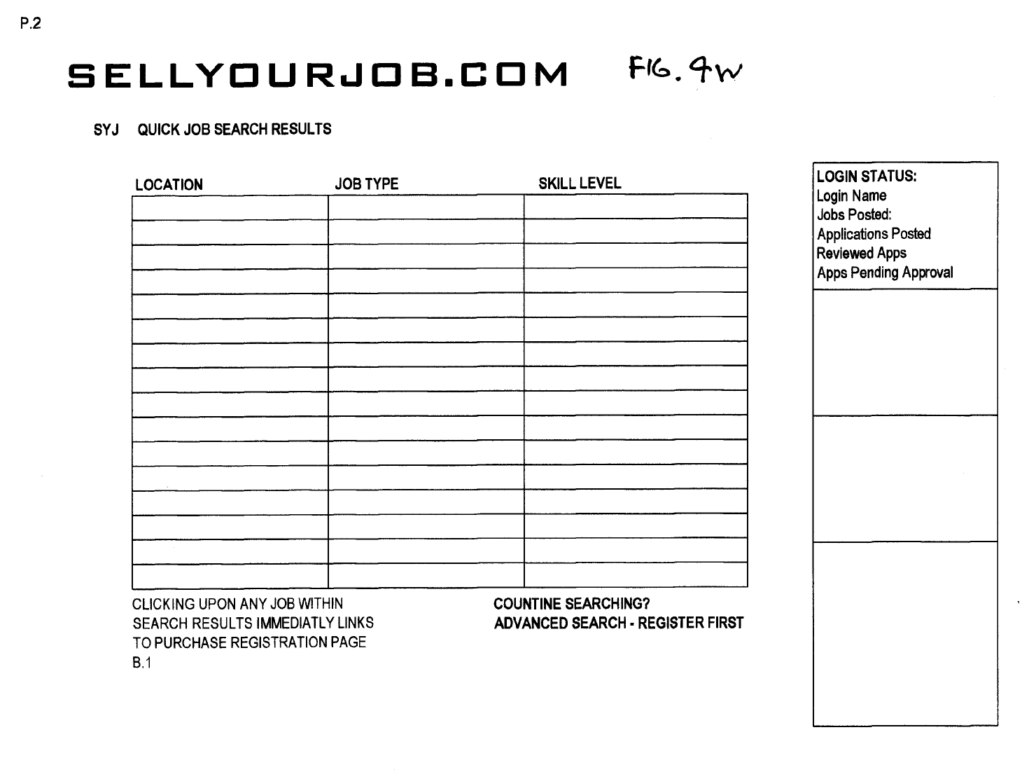

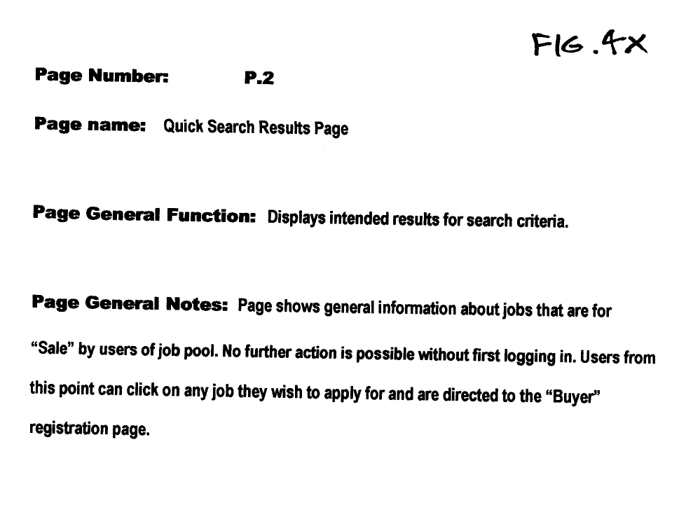

As previously noted, the system may provide one or more GUIs associated with each of the interface modules and sub-modules. Merely by way of example, FIGS. 4A-4X includes a series of sample screen shots or pages of various user interfaces, accompanied by a brief description of the page. It should be understood that these pages merely schematically illustrate a basic implementation of interfaces utilized in connection with the modules are not intended to be limiting in any way, and any and all implementations within the knowledge of one of ordinary skill in the art of web design, computer programming and/or marketing and service providers are intended to be covered herein by the broad principles of the present invention.

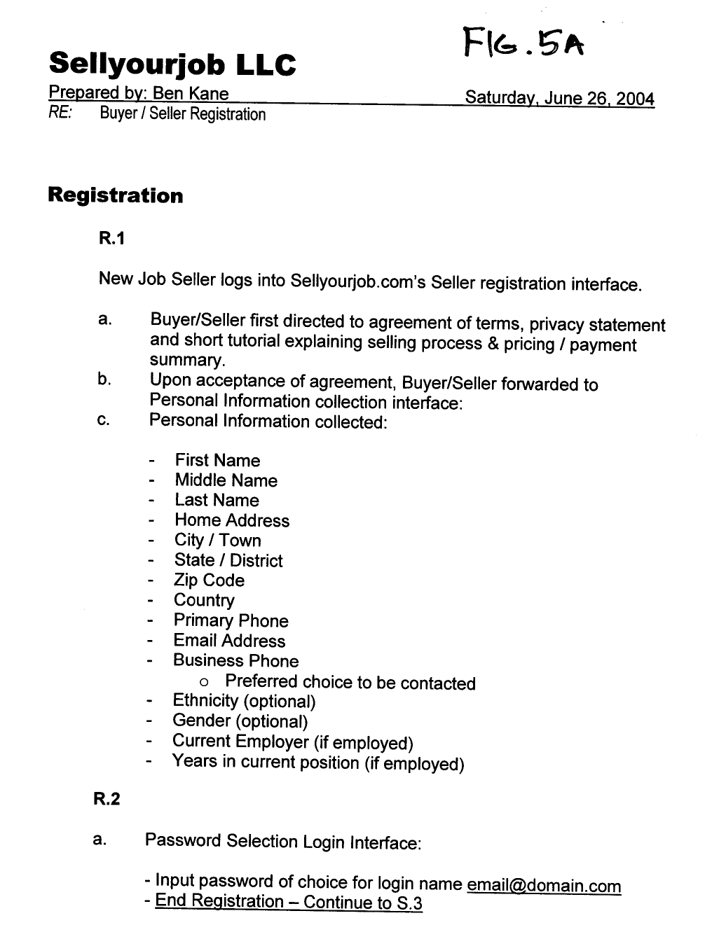

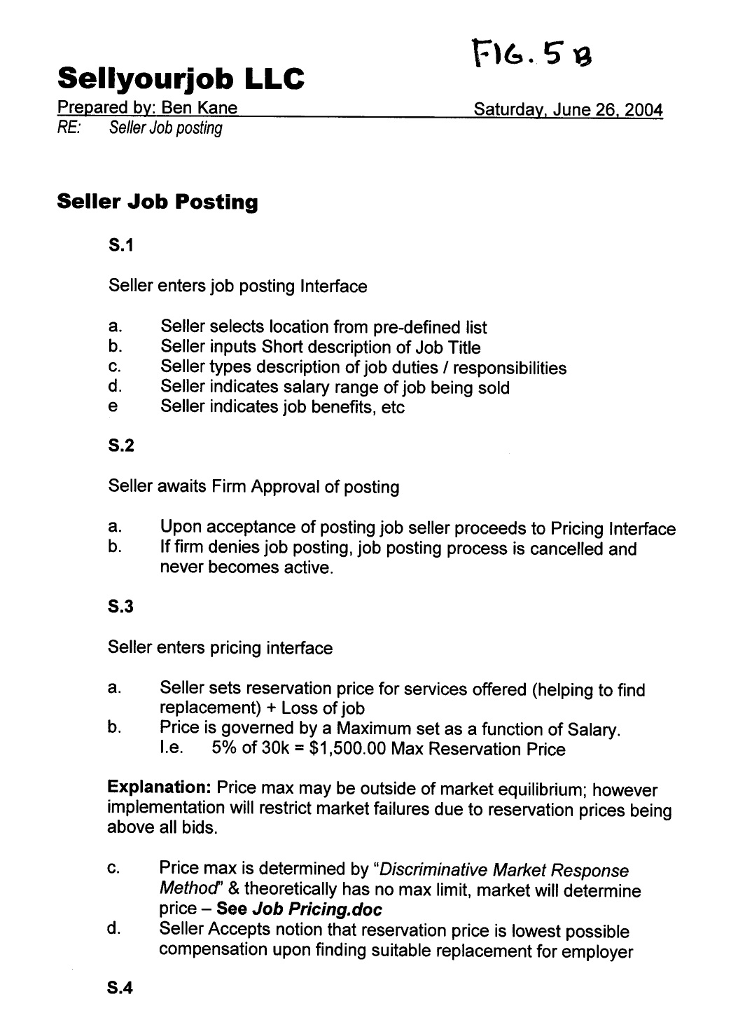

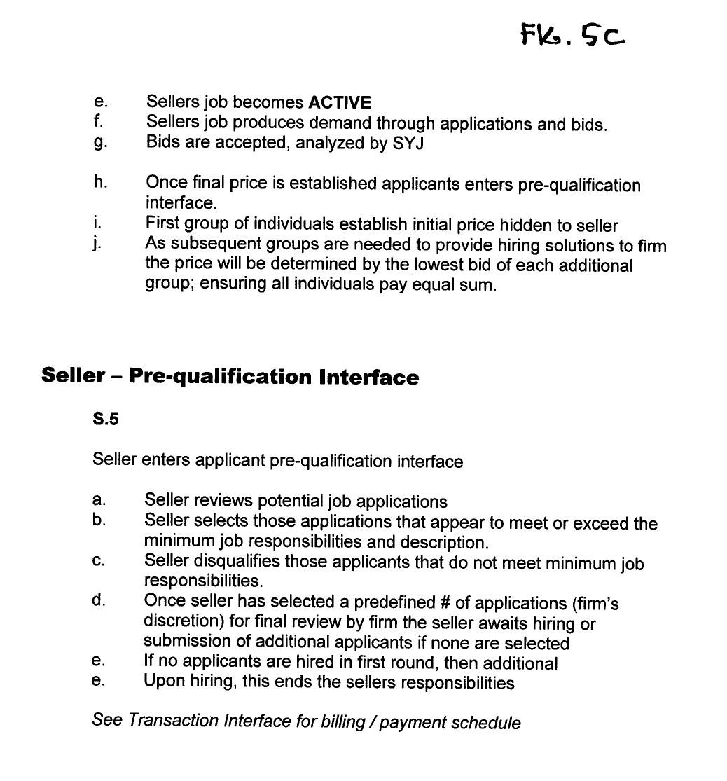

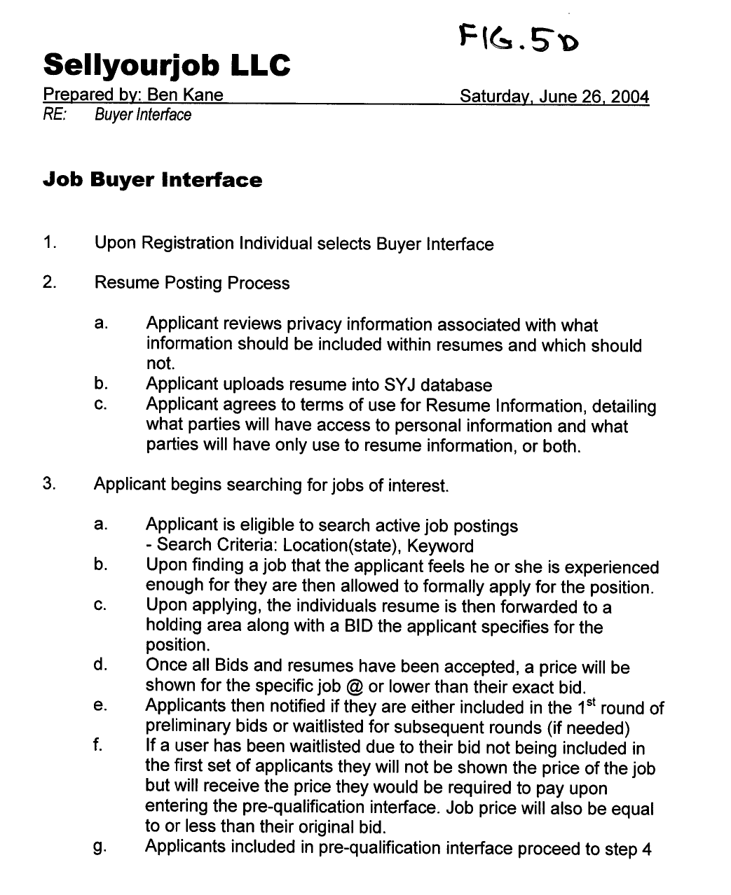

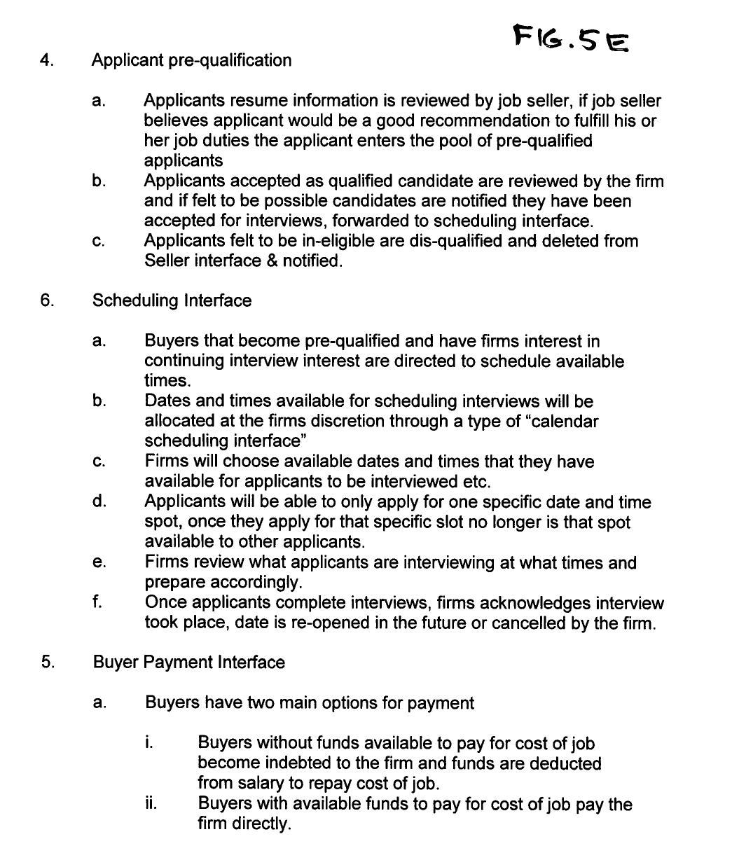

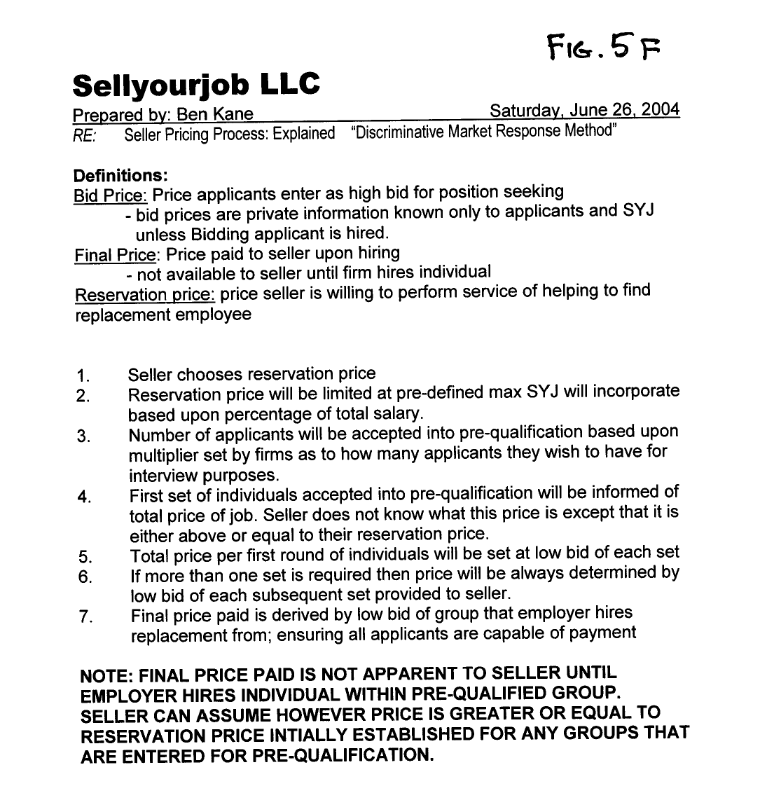

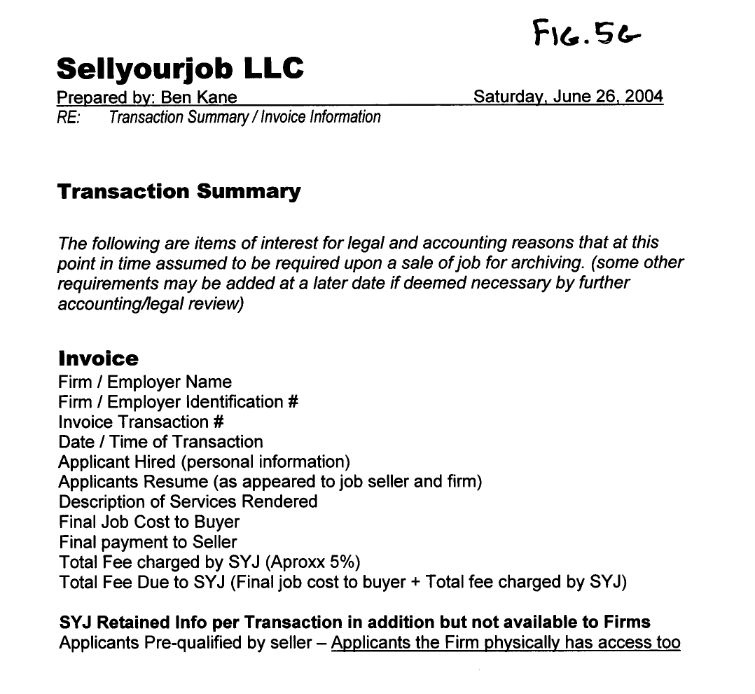

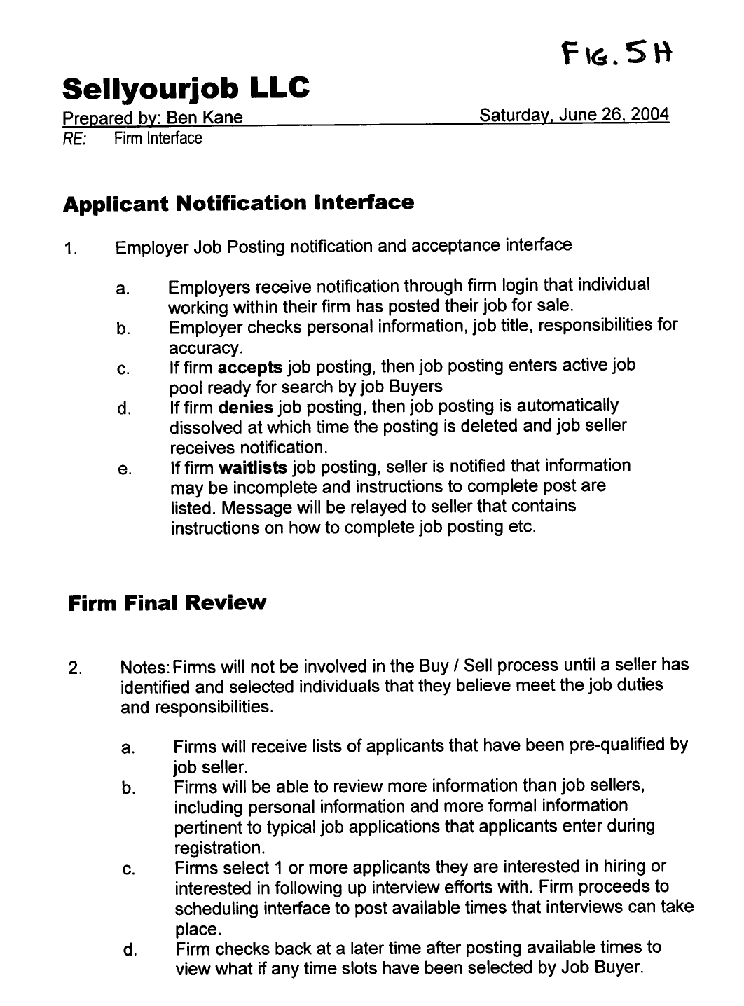

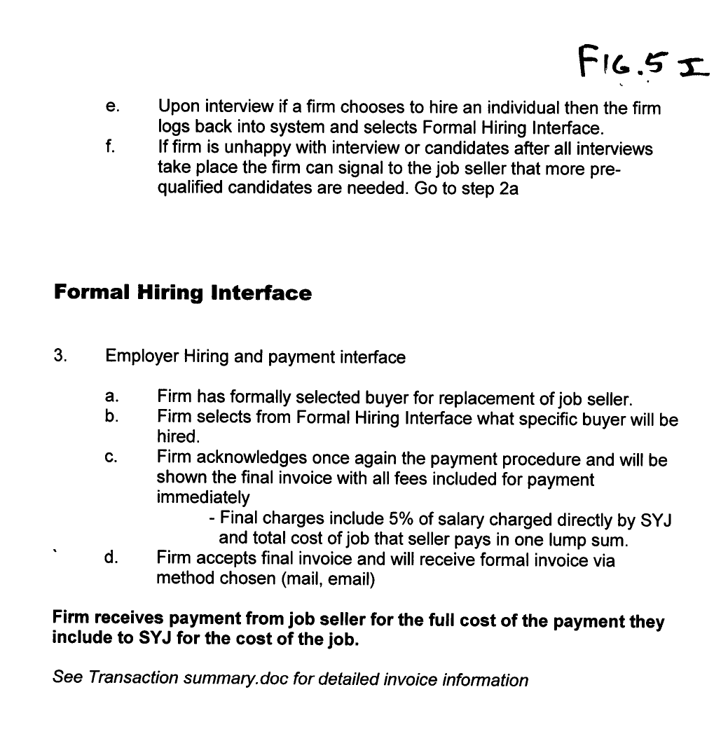

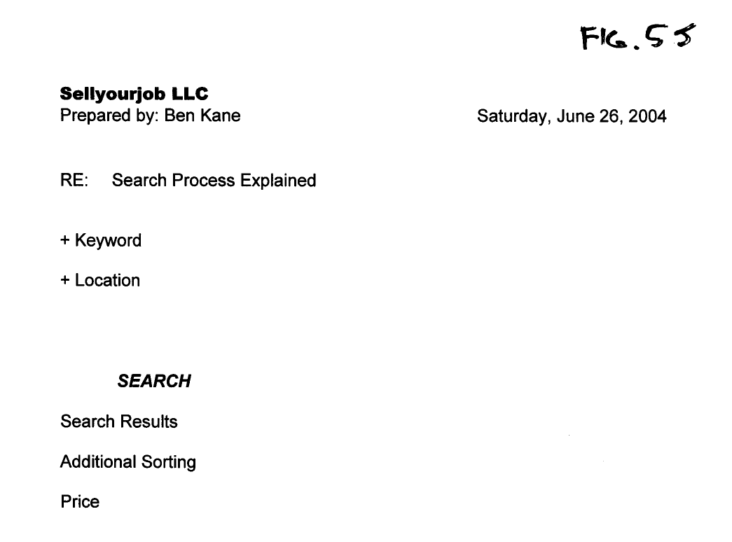

To further illustrate the principles of the invention, various features and options of the interfaces are provided and described in more detail in FIGS. 5A-5J, with the understanding that the following detailed descriptions are not intended to be limiting in any way, but rather provided to one of ordinary skill in the art as possible elements of implementation of the broad principles of the present invention.

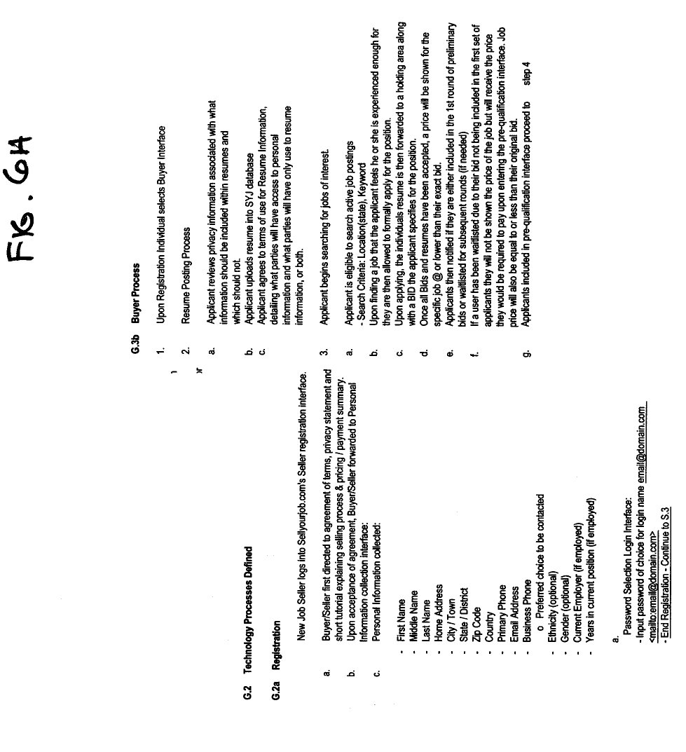

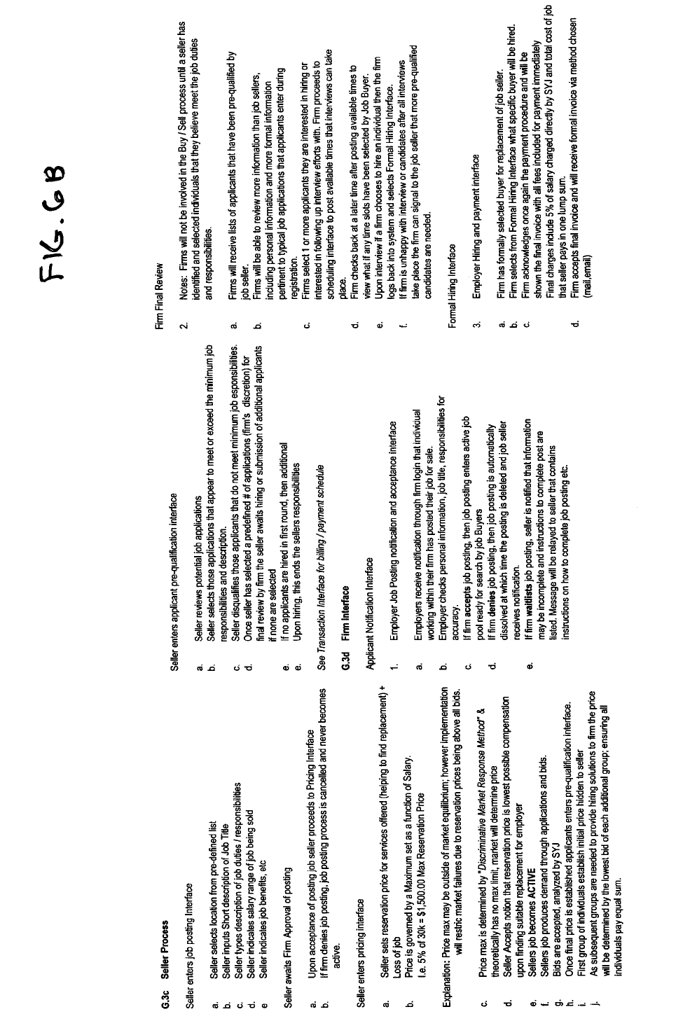

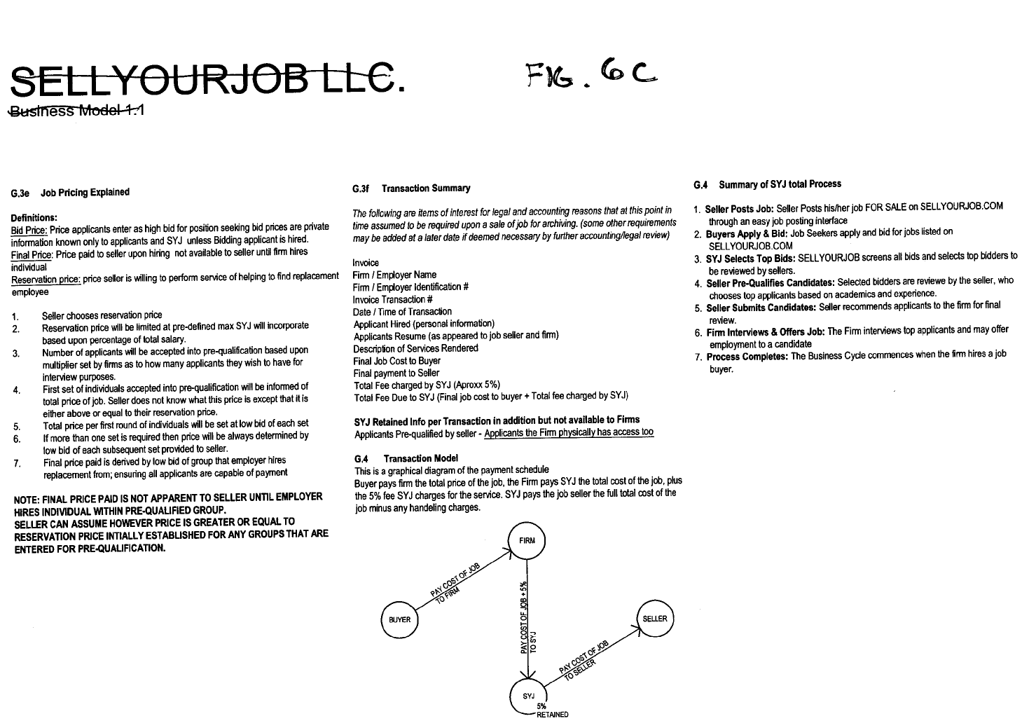

A preferred implementation of the process is described in FIGS. 6A-6C.

Financial Models

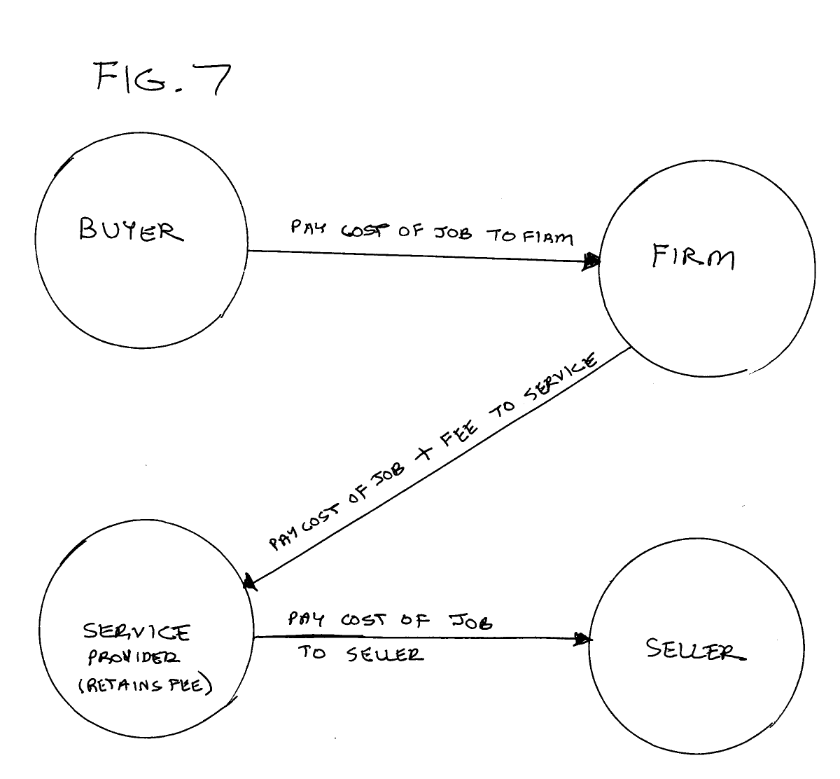

A preferred financial transaction embodiment is illustrated in FIG. 7. In this particular embodiment, a financial model is implemented wherein the buyer pays the firm the total price of the job and the firm pays the service provider the total cost of the job plus an additional fee for the service. The fee can be a percentage of the price of the job, a predetermined flat fee, or other arrangement. Preferably, the service provider pays the seller the full total price of the job, less handling charges.

It should be understood that other financial models could be implemented to maximize incentives to each of the parties involved in the transaction. For example, other financial models may include features such as payment by the firm of the cost of the job on behalf of the buyer, financing of the cost of the job by the firm on behalf of the buyer, or shared payment of the price of the job amongst one or more parties.

While specific embodiments have been illustrated and described herein and in the figures, numerous modifications may come to mind without significantly departing from the spirit of the invention, and the scope of protection is only limited by the scope of the accompanying claims.

1. A method for facilitating a sale of an employment position with an employer from an employee possessing the employment position, the method comprising the steps of:
accepting information from the employee relating to the position, the information including a price associated with the position;
verifying the information;
publishing the information such that it is accessible to a plurality of individuals seeking employment;
accepting an application for the position from at least one of the plurality of individuals; and
effectuating payment of the price associated with the position from the at least one of the plurality of individuals to the employee after approval by the employer of the at least one of the plurality of individuals.

2. A method for facilitating a sale of an employment position with an employer from a seller possessing the employment position, the method comprising the steps of:
providing a seller interface that allows the seller to post information relating to the seller's employment position in a database, the information including a price for the position;
providing a buyer interface that allows a buyer to search the database and submit an application for the position;
providing an employer interface that allows verification of the position, acceptance of the application, and approval of the buyer; and
facilitating payment of the price from the buyer to the seller after approval of the buyer by the employer.

3. A server-based system for facilitating a sale of an employment position with an employer from a seller possessing the employment position, the system comprising:
a seller interface that allows the seller to post information relating to the seller's employment position in a database, the information including a price for the position;
a buyer interface that allows a buyer to search the database and submit an application for the position; and
an employer interface that allows verification of the position, acceptance of the application, and approval to complete the sale.

4. A system for facilitating a sale of an employment position with an employer from a seller possessing the employment position, the system comprising a computer-readable storage medium; means recorded on the medium for facilitating accepting of the information from the seller relating to the position, the information including a price associated with the position; means recorded on the medium for facilitating verifying of the information; means recorded on the medium for facilitating publishing of the information such that it is accessible to a plurality of individuals seeking employment; and means recorded on the medium for facilitating accepting of an application for the position from at least one of the plurality of individuals.

5. The system of claim 6, further comprising means recorded on the medium for facilitating payment of the price associated with the position from the at least one of the plurality of individuals to the employee after approval by the employer of the at least one of the plurality of individuals.
